(19) United States
(12) Patent Application Publication
(10) Pub. No.: US 2026/0349807 A1
(43) Pub. Date: Nov. 5, 2026

(54) Adapter-Based Extension of a Base Model

(71) Applicant: Microsoft Technology Licensing, LLC, Redmond, WA (US)

(72) Inventors: Pashmina Jonathan CAMERON, Cambridge (GB); Henry Richard JACKSON-FLUX, Cambridge (GB); Eric Chris Wolfgang SOMMERLADE, Oxford (GB); Karthik VIJAYAN, Reading (GB); Justin James WAGLE, Pacifica, CA (US)

(73) Assignee: Microsoft Technology Licensing, LLC, Redmond, WA (US)

(21) Appl. No.: 19/195,702

(22) Filed: Apr. 30, 2025

(51) Int. Cl. G06F 9/50

(52) U.S. Cl. CPC G06F 9/5027

(57) ABSTRACT

A technique enables extension of the capabilities of a base model in a time-efficient and resource efficient manner. The technique includes receiving one or more adapter models from a network-accessible source. The base model and each adapter model have quantized weights and are configured to receive and produce quantized activations. The technique uses a same base model, operating in conjunction with any of the adapter model, to map input items to task-specific responses. This mapping is performed on a hardware accelerator unit of a client system, such as a neural processing unit. In training, a training system trains and quantizes each adapter model against a quantized version of the base model.

### BACKGROUND

In current practice, users typically download standalone applications with artificial intelligence capabilities directly from a developer-sponsored website, or from a source of open-source code. This approach has various shortcomings. Current machine-trained models include a large number of parameters (e.g., several billion parameters in the case of many language models). A user computing device may have insufficient memory and processor resources to successfully store and run these machine-trained models. It is further a time-intensive and resource-intensive task to periodically update these machine-trained models. These problems are compounded when a user wishes to locally run two or more applications with artificial intelligence capabilities. An application developer may reduce the impact of these problems by configuring its application to interact with a server-side machine-trained model. Yet some users may be reluctant to interact with server-side machine-trained models because of privacy-related concerns. Further, a network connection is not always available.

### SUMMARY

A technique is described herein for extending the capabilities of a base machine-trained model (“model”) in a time-efficient and resource-efficient manner. The technique includes receiving, by a client system, one or more adapter models from one or more sources. The client system uses a same base model, operating in conjunction with any of the adapter models, to map input items to task-specific hidden state results. More generally, each adapter model has the effect of adapting the base model to perform a specific task on the client system.

Among other technical advantages, the technique reduces the amount of resources that are required to store and run machine-trained models. This is achieved by the use of adapter models instead of standalone machine-trained models. This technical feature makes it more feasible to run a machine-trained model on a user computing device or other resource-constrained computing device, which, in turn, eliminates or reduces the need to interact with server-side machine-trained models. (However, it is possible to implement the technique on any computing platform.)

Further, the technique enables new capabilities to be built around the same base model in a structured, regulated, and resource-efficient manner. It performs this task, in part, by providing a consistent protocol and accompanying framework for ensuring that any developed adapter model is compatible with the base model, regardless of when it was produced. This technical feature facilitates and expedites the task of developing and maintaining one or more applications that have artificial intelligence capabilities. The technique is scalable in this regard.

According to another aspect, in inference, the weights of the adapter models are kept separate from the weights of the base model in memory. This technical feature enables adapter models to be coupled to the base model in flexible ways during inference. For instance, this technical feature allows two or more adapter models to work in conjunction with the base model at the same time, which is not possible or feasible with respect to alternative approaches which fuse weights of different models at the time of inference.

According to another aspect, both the base model and the adapter model that are received have quantized weights, and are configured to receive and produce quantized activations. According to another aspect, the adapter model is trained and quantized with reference to a quantized version of the base model. The use of quantized weights and activations further reduces the resource requirements of machine-trained models, and thus further promotes the goal of running machine-trained models on resource-constrained computing devices.

According to another aspect, the base model and the one or more adapter models execute operations on a hardware accelerator unit of a client system. For example, the hardware accelerator unit is a neural processing unit (NPU) of a client computing device.

According to another aspect, the mapping includes: using the adapter model in conjunction with the base model to map the input item to a hidden state result; and using a head neural network to map the hidden state result to the task-specific response on a central processing unit of the client system.

According to another aspect, the technique includes, in an embedding neural network that runs on the central processing unit of the client system, mapping the input item to input-item embedding information, wherein the adapter model and the base model operate on the input-item embedding information.

The above-summarized technology is capable of being manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows a model extension system for extending the capability of a base machine-trained model (“model”) using one or more adapter models.

FIG. 2 shows an example of a manner in which two adapter models are capable of interacting with a base model.

FIG. 3 shows another example of a manner in which two adapter models interact with a base model.

FIG. 4 shows one implementation of a client system that operates using a base model and one or more adapter models.

FIG. 5 shows additional details regarding the client system of FIG. 4.

FIGS. 6 and 7 show two different implementations of a training system.

The training system trains and quantizes new adapter models for use by client systems.

FIG. 8 shows one manner of operation of a training system for training and quantizing an adapter model.

FIG. 9 illustrates the concept of a quantization scale factor and zero point.

FIG. 10 is a flowchart that provides an overview of one manner of operation an adapter management system, which is a component of the model extension system of FIG. 1.

FIG. 11 is a flowchart that provides an overview of one manner of operation of a client system in the model extension system of FIG. 1.

FIG. 12 shows an illustrative language model for implementing a base model and/or an adapter model for use in the client extension system of FIG. 1.

FIG. 13 shows computing equipment that, in some implementations, is used to implement the model extension system of FIG. 1.

FIG. 14 shows an illustrative type of computing system that, in some implementations, is used to implement any aspect of the features shown in the foregoing drawings.

The same numbers are used throughout the disclosure and figures to reference like components and features.

### DETAILED DESCRIPTION

### A. Model Extension System

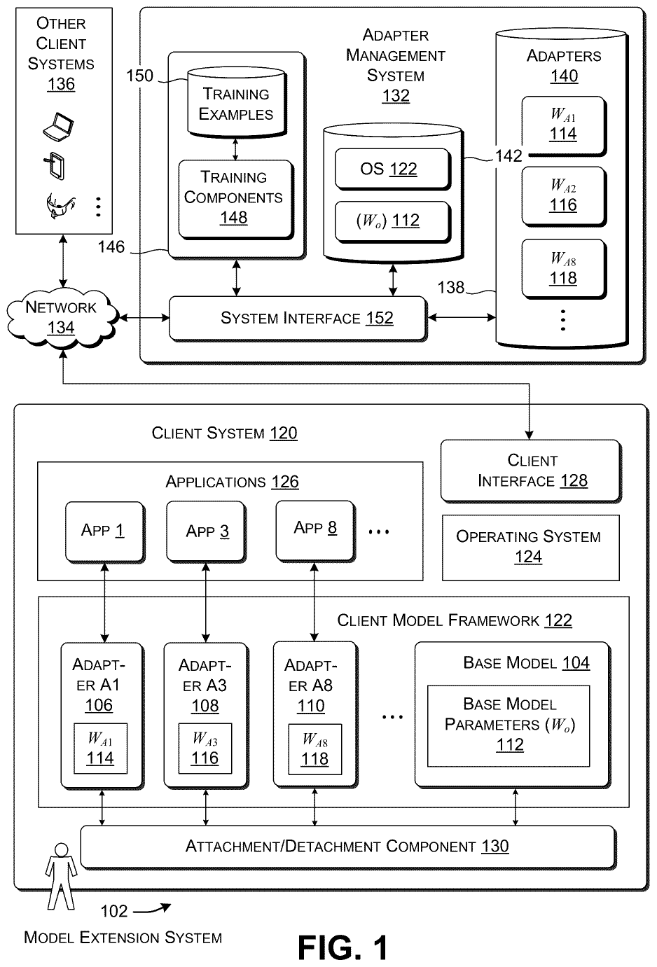

FIG. 1 shows a model extension system 102 for extending the capability of a base machine-trained model (“model”) 104 using one or more adapter models (106, 108, 110, . . . ). In some implementations, each adapter model and the base model 104 is a neural network that is instantiated by a set of machine-trained parameters (e.g., weights, bias values). For instance, the base model 104 includes a set of base model parameters Wₒ 112, and the adapter models (106, 108, 110) include respective sets of adapter model parameters (114, 116, 118).

A client system 120 includes a client model framework 122 in which the base model 104 and the adapter models (106, 108, 110) execute operations. For example, the client system 120 is a user computing device of any type (e.g., a laptop computing device, a smartphone, a media device, an extended reality device, and so on). In some implementations, the client model framework 122 is a hardware accelerator unit of the client system 120. For example, the client model framework 122 is a neural processing unit (NPU) of the client system 120. Other types of hardware accelerator units include vision processing units (VPUs), graphics processing units (GPUs), field-programmable gate arrays (FPGAs), tensor processing units (TPUs), application-specific integrated circuits (ASICS), neuromorphic processing units, and so on. The client system 120 also includes an operating system 124 and a set of one or more applications 126. FIG. 1 shows that the applications 126 include a set of at least three applications (app 1, app 3, and app 8). Alternatively, or in addition, the client system 120 interacts with one or more network-accessible applications (not shown) via the client network interface 128.

Different implementations of the client model framework 122 can use different strategies for storing models in its memory. In one implementation, a hardware accelerator unit loads the base model 104 and one or more adapter models when they are invoked by an application. In another implementation, a hardware accelerator unit maintains the base model 104 in its memory at all times. A hard disk unit stores models that are not being invoked.

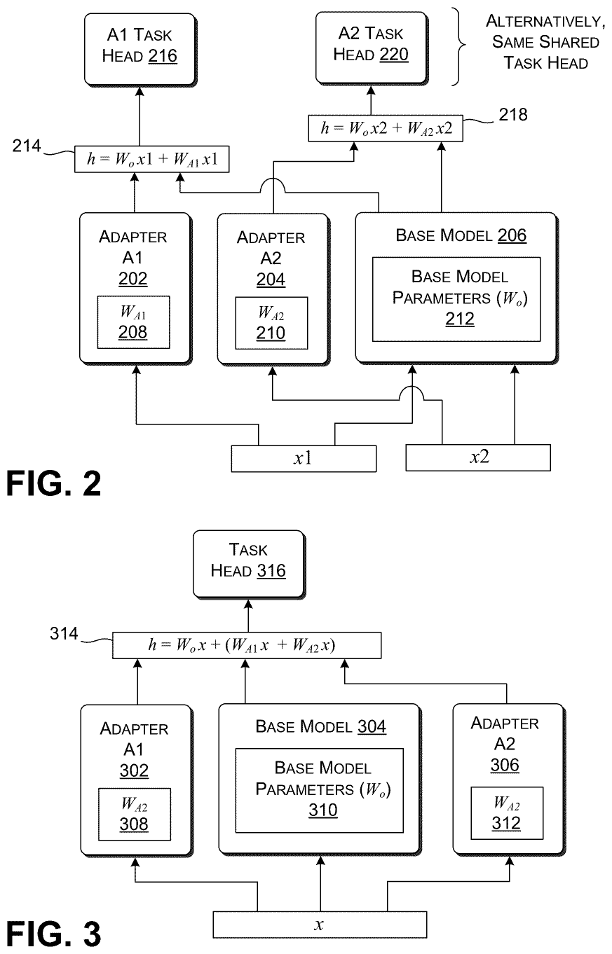

In inference, the adapter models are separately maintained in memory. This allows more than one adapter model to be attached at a time to the base model 104 during inference, as will be described below with reference to FIGS. 2 and 3. This is distinct from an alternative technique in which the weights of an adapter model are merged with the weights of the base model 104 during inference. The alternative technique of hot-swapping adapter models in memory, which involves merging weights in inference, does not allow inferencing against more than one adapter model in parallel.

At least some of the applications perform functions that rely on one or more machine-trained models. Each of the machine-trained models, in turn, is implemented by one or more of the adapter modules (106, 108, 110) that operate in conjunction with the base model 104. For example, the application app1 performs at least one function that relies on the adapter model A1 106, which operates in conjunction with the base model 104. The application app3 performs at least one function that relies on the adapter model A3 108. The application app8 performs at least one function that relies on the adapter model A8 110, which operates in conjunction with the base model 104. However, there is not necessarily a one-to-one correspondence between applications and adapters. For example, plural applications can interact with the same adapter model.

This section will describe in detail what “operates in conjunction with” means. As a preview to that later explanation, in some implementations, each invoked machine-trained model, associated with a particular adapter model (for example, the adapter model A1 106), operates on an input item x in the following manner. Item x refers to at least one distributed vector that represents some portion of content, such as a passage of text or part of an image. The base model 104 maps the input item x to a first hidden state result Wₒx using its base model parameters Wₒ. The adapter model A1 106 maps the input item x to a second hidden state result W_{A1}x using its own model parameters W_{A1} 114. A combining operation (not shown) sums the first hidden state result and the second hidden state result to provide a combined hidden state result, and a head neural network (not shown) maps the hidden state result to a task-specific response. The application app1 provides some function based on the task-specific response. In one example, the app A1 is a video conferencing application, and the invoked machine-trained model is a classification model that maps a portion of a dialogue to a sentiment class or an intent class.

The explanation to follow principally focuses on the above example in which the adapter model operates in parallel with the base model. But the principles set forth herein are applicable to other adapter configurations, such as a configuration in which one or more adapter models operate in series with the layers of the base model. In some implementations, an adapter model that operates in series includes a down-projection feed-forward layer, a non-linear operation layer, and an up-projection feed-forward layer. Further, the principal example set forth herein focuses on a LoRA configuration in which the adapter model uses two low-rank weight matrices. But other configurations use a single weight matrix or more than two weights matrices. Further, the weight matrices (or matrix) of the adapter can be of any rank. For instance, adapters predicated on singular value decomposition include three (or more) weight matrices.

Different adapter models adapt or extend the fixed functionality of the base model 104 to different respective tasks. For example, the adapter model A1 106 may work in conjunction with the base model 104 to perform an entity classification task. The adapter model A8 110 may work in conjunction with the base model 104 to perform a text summarization task. Other adapter models operate on other types and combinations of types of information items (e.g., images, audio items, videos) in conjunction with the base model 104. The base model 104 in all such applications is said to be fixed because it uses the same set of frozen base model parameters Wₒ 112 for all of these different tasks, in both the training and inference stages of an adapter model.

Each adapter model includes a set of parameters that, in some implementations, is less than the number parameters in the base model parameters Wₒ 112. For example, in one implementation, there are 3.3 billion parameters in Wₒ 112, and these parameters use about 6 GB of hard disk to store. The adapter model(s) collectively use hundreds of megabytes of memory. As stated above, in some implementations, each adapter model includes two low-rank weight matrices. The product of the two low-ranked matrices has the same number of entries as the base model 104, but the low-rank weight matrices themselves include much fewer parameters than the base model 104.

There are several technical advantages to the model extension system 102 described above. First, the client system 120 typically has limited memory, processor, power, and communication resources. The model extension system 102 reduces the amount of storage space and memory that is necessary to store and run machine-trained models. This is because the model extension system 102 uses adapter models that encode the unique functionality of the machine-trained models, rather than providing standalone machine-trained models having respective sets of full parameters. This storage efficiency allows the client system 120 to locally run some machine-trained models it otherwise could not if these models were expressed as standalone collections of weights. Local execution avoids the need to send private input items to an online model implemented by a server system.

Second, the model extension system 102 is capable of updating any machine-trained model by receiving an updated version of the adapter model associated with the machine-trained model. The base model 104 remains unmodified. This reduces the amount of time and network bandwidth that is consumed in the update process. It also simplifies the maintenance of the machine-trained models.

Third, the model extension system 102 is scalable and readily extensible insofar as it readily accommodates the introduction of new adapter models without undermining any existing adapter models. A training system (to be described below) achieves this result by ensuring that any newly developed adapter model is compatible with the base model 104, which remains fixed. More specifically, the training system ensures that the quantization and encryption used by the new adapter model are compatible with the quantization and encryption used by the base model 104, which remains fixed. Quantization refers to reducing the sizes of information items that are used to represent original parameters and activations, e.g., by changing the information items from floating point values (e.g., 32-bit floating point values) to integer values (e.g., 2-bit, 4-bit, 8-bit, or 16-bit integer values). Overall, quantization reduces the size of the adapter models (106, 108, 110) and the base model 104. Further, the neural processing unit may operate in the realm of integer values, not floating point values.

An attachment/detachment component 130 provides functionality for adding and removing adapter models from the client model framework 122. Attaching a new adapter model involves linking its functionality to the functionality of the base model 104, e.g., using pointers and/or other address-linking mechanisms.

In some implementations, the client system 120 as originally acquired by a user includes the operating system 124, a subset of initial applications, a subset of initial adapter models, and the base model 104. Thereafter, the user remains free to acquire additional adapter models from an adapter management system 132. FIG. 1 specifically shows an example in which the client system 120 is communicatively coupled to the adapter management system 132 via a communication network 134 of any type (e.g., the Internet). Other client systems 136 likewise interact with the adapter management system 132 via the network 134. Each client system may include its own unique subset of adapter models based on the needs and interests of a specific user

A user of the client system 120 likewise remains free to delete an adapter model for any reason, e.g., because its functionality is no longer needed, or the user wishes to create storage space to store newly acquired adapter models. Alternatively, or in addition, a user may choose to store some adapter models obtained from the adapter management system 132 on an auxiliary storage device (not shown), such as a portable hard drive. When invoked, the parameters of an adapter model are loaded into the client model framework 122.

In some implementations, the adapter management system 132 includes a data store 138 for storing a collection of trained and quantized adapter models 140. FIG. 1 shows that the collection includes at least the parameters (114, 116, 118) of the adapter models (106, 108, 110) that are currently installed on the client system 120. The adapter management system 132 also includes one or more stores 142 that store the operating system 124 and the parameters Wₒ 112 of the base model 104.

In some implementations, the adapter management system 132 also includes a training system 146 for training new adapter models. The training system 146 performs this task using one or more training components 148 that operate on a set of training examples in a data store 150. In some examples, the adapter management system 132 includes pre-generated sets of training examples that can be used by a user (e.g., an end user or developer) to train different types of functions. Alternatively, or in addition, a user may upload a custom set of training examples that pertain to the model the user wishes to train. Although not shown, a configuration interface hosted by the adapter management system 132 enables a user to choose other characteristics of a training operation, including the loss function, the hyper-parameters, the number of epochs, etc. Whatever choices are made by an individual user, the training system 146 ensures that the adapter model that is produced uses a form of quantization and encryption that is fully compatible with the base model 104, and is therefore able to work with the base model 104 without the user needing to perform ad hoc adjustments on the adapter model that is downloaded.

Alternatively, or in addition, the client system 120 may host its own training system (not shown) based on a training software development kit (SDK) provided by the adapter management system 132. This training software ensures that any adapter that is produced is compatible with the base model 104. In addition, any user can upload a locally-trained adapter model to the adapter management system 132. The user may designate the uploaded adapter model for private use by one or more particular individuals or for public use. In the latter case, a compliance system (not shown) hosted by the adapter management system 132 ensures that the uploaded adapter model complies with applicable privacy, safety, and compatibility standards.

In some implementations, the adapter management system 132 also hosts a marketplace service by which any user is able to browse for available adapter models. A description of each adapter model provided by the marketplace service identifies its function, the privileges it requires, the resource it uses, its age appropriateness, its popularity score, its price (if applicable), and so on.

A system interface 152 provides an interface by which users may interact with any of the above subsystems of the adapter management system 132.

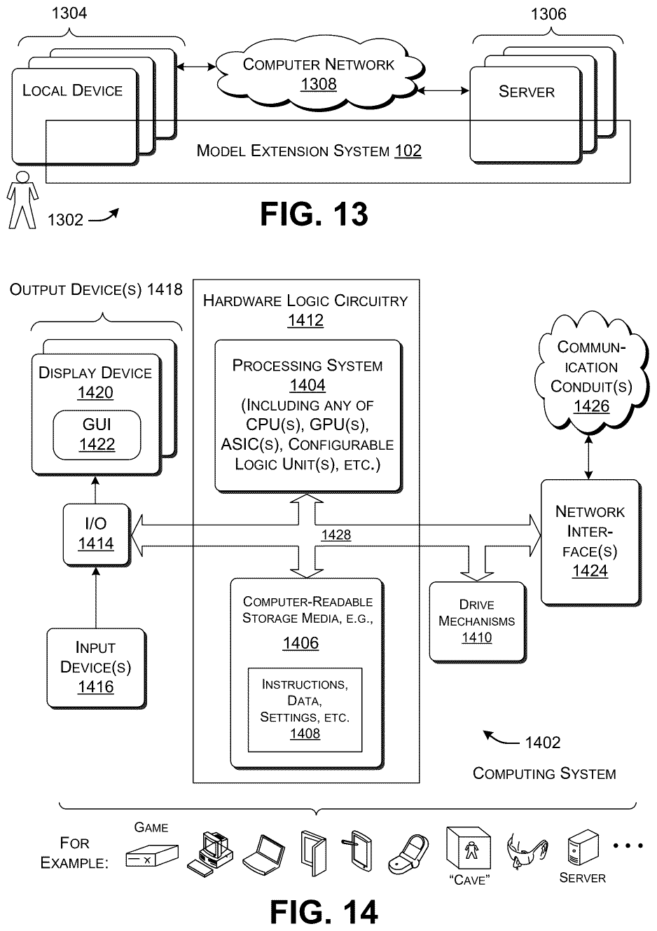

The remaining figures of this section provide further details regarding the features shown in FIG. 1. As stated above, this explanation focuses on the example in which one or more adapter models operate in parallel with the base model. But other implementations connect one or more adapter models in series with the layers of the base model. The following terminology is relevant to some examples presented below. A “machine-trained model” or “model” refers to computer-implemented logic for executing a task using machine-trained weights that are produced in a training operation. A “parameter” or “weight” refers to any type of parameter value that is iteratively produced by the training operation. For example, a parameter may correspond to a filter weight. A “token” refers to a unit of information processed by a machine-trained model, such as a word or a part of a word. In some cases, a tokenizer produces the tokens, but an item (e.g., a text passage) is said to be composed of tokens in a general sense (in which “token” is a synonym of “part”), irrespective of when and where those tokens are actually produced. A “prompt” refers to a sequence of tokens submitted to a machine-trained model. A “distributed vector” or embedding expresses the semantic content of an information item by distributing information over its k dimensions. In some contexts, terms such as “component,” “module,” “engine,” and “tool” refer to parts of computer-based technology that perform respective functions. FIGS. 13 and 14, described below, provide examples of illustrative computing equipment for performing these functions.

FIG. 2 shows an example of a manner in which two adapter models (202, 204) are capable of interacting with a base model 206. The first adapter model A1 202 includes parameters 208, the second adapter model A2 204 includes parameters 210, and the base model 206 includes fixed parameters 212. When invoked, the first adapter model A1 202 maps an input item x1 into a first hidden state result and the base model 206 maps the input item x1 into a second hidden state result. A combination component 214 sums the first hidden state result and the second hidden state result, to provide a combined result. A task-specific head neural network 216 maps the combined result to a task-specific response, which is forwarded to a first application (not shown).

Similarly, when invoked, the second adapter model A2 204 maps an input item x2 into a first hidden state result and the base model 206 maps the input item x2 into a second hidden state result. A combination component 218 sums the first hidden state result and the second hidden state result, to provide a combined result. A task-specific head neural network 220 maps the combined result to a task-specific response, which is forwarded to a second application (not shown). FIG. 2 shows that the first head neural network 216 is distinct from the second head neural network 220, but, in another implementation, a single shared head neural network is able to combined results produced by either adapter model (202, 204).

In some implementations, the first adapter model A1 202 and the second adapter model A2 204 are invoked at different respective times. In other implementations, the first adapter model A1 202 interacts with the base model 206 at the same time as the second adapter model A1 202 interacts with the base model 206. But even in this case, the base model 206 ensures that the processing flows associated with the two adapter models (202, 204) are kept separate. The

FIG. 3 shows an example in which an adapter model A1 302 interacts with a base model 304 to map an input item x to a first and second hidden state results. At the same time, a second adapter model A2 306 interacts with the base model 304 to produce a third hidden state result. The first adapter model A1 302, base model 304, and second adapter model A2 306 use respective sets of machine-trained parameters (308, 310, 312). A combination component 314 combines the hidden state results together to provide a combined result. A head neural network 316 maps the combined result to a task-specific response, which is provided to an application. From a more general standpoint, FIG. 2 is one example in which two or more adapter models operate in parallel (with respect to their interaction with the base model 104), to produce separate results given separate input items. FIG. 3 is one example in which two or more adapter models interact with the base model 104 to contribute to a single result. The model extension system 102 is capable of flexibly combining adapter models in different ways to accommodate the needs of different applications because it separately maintains the adapter models in memory at inference, rather than merging the adapter model weights with the weights of the base model 104,

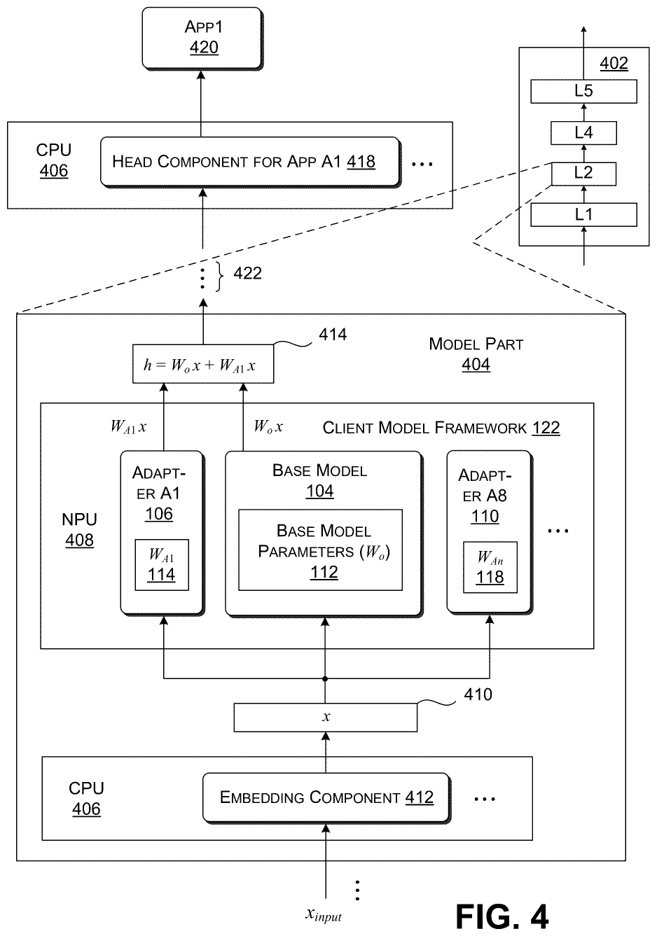

FIG. 4 shows a neural network 402 that includes plural layers (L1, L2, L3, etc.). Each layer corresponds to a model part. FIG. 4 shows a model part 404 that is used to implement one of the layers. For example, the model part 404 is used to implement a feed-forward layer in a convolutional neural network, or an attention layer of a transformation block of a transformer neural network. However, in some implementations, only some of the plural layers have counterpart adapters. In other words, there is no requirement that adapters be applied to every operation in a machine-trained model.

During inference, the model part 404 executes some operations using a central processing unit 406 and other operations using a hardware accelerator unit, such as a neural processing unit (NPU) 408. More specifically, the NPU 408 executes operations of the base model 104 having parameters Wₒ 112, the adapter model A1 106 having parameters W_{A1} 114, and the adapter model A8 110 having parameters W_{AB} 118. At a current time, FIG. 4 shows that the adapter model A1 106 is working in conjunction with the base model 104 to map an input embedding x 410 to a first hidden state result (W_{A1}x) and a second hidden state result (Wₒx), respectively.

An embedding component 412 (e.g., an embedding neural network) maps an input item xᵢₙₚᵤₜ to the input embedding x 410. In some implementations, embedding component 412 implements the encoding layers of the neural network 402. For example, in the text domain, the embedding component 412 uses a tokenizer to partition the input item into tokens. A “token” refers to a unit of text having any granularity, such as an individual word, a word fragment produced by byte pair encoding (BPE), a character n-gram, a word fragment identified by the WordPiece or SentencePiece algorithm, etc. To facilitate explanation, assume that each token corresponds to a complete word.

Next, the embedding component 412 maps the sequence of tokens into respective token embeddings. For example, the embedding component produces one-hot vectors that describe the tokens, and then maps the one-hot vectors into the token embeddings using a machine-trained linear transformation. The embedding component then adds position information (and, in some cases, segment information) to the respective token embeddings to produce position-supplemented embeddings. The position information added to each token embedding describes the token embedding's position in the sequence of token embeddings. In other implementations, the embedding component 412 operates on individual pixels or patches in a neural network, a segment of audio information, a frame of video information, and so on.

A combination component 414 combines the first hidden state result with the second hidden state result (e.g., by adding the results together), to produce a combined result. A head component 416 (e.g., a head neural network) maps the combined result to a task-specific response. An application app1 420 performs some function based on the task-specific response.

In some implementations, the head component 418 is implemented by a neural network of any type, such as a linear neural network, or a multilayer perceptron. In some implementations, the head component 418 also includes a Softmax layer (e.g., a normalized exponential function) that maps logits produced by a linear neural network to a classification result or a next token prediction. In some implementations, both the embedding component 412 and the head component 416 execute operations in inference using the central processing unit (CPU) 406.

The ellipses 422 indicates that other model parts include their own respective instantiations of the model part functionality shown in FIG. 4. Generally, different model parts can use level-specific instantiation of a base model, layer-specific implementations of adapter models, different quantization sizes, different quantization scale factors, etc. However, as noted above, there is no requirement that every layer of a model have a counterpart adapter model.

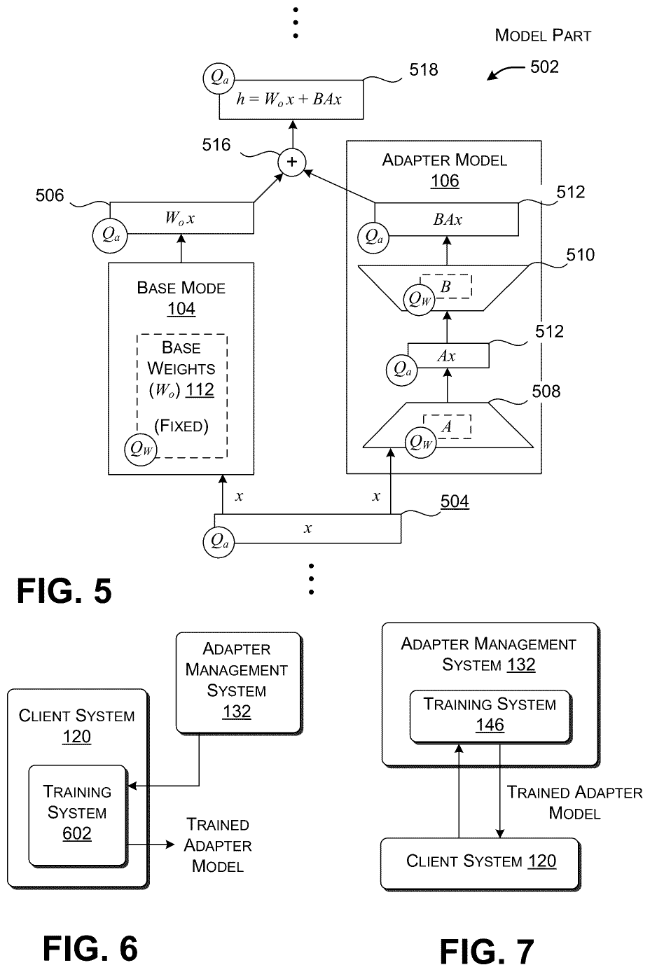

FIG. 5 shows yet additional details regarding an implementation of a model part 502, again, focusing on the non-limiting example in which the base model 104 operates in parallel with an adapter model. That is, the model part 502 includes the base model 104, which, in turn, uses a set of base parameters Wₒ 112. In a forward pass of inference, the base model 104 maps an input embedding x 504 to a first hidden state result Wₒx 506. The model part 502 performs this task by multiplying the input embedding x 504 by a matrix defined by the base parameters Wₒ 112. In a rightmost forward pass, the adapter model A1 106 includes two feed-forward layers (508, 510) in series, which map the input embedding x 504 to a second hidden state result 512 (BAx). More specifically, the first feed-forward layer 508 multiplies the input embedding x 504 by a first weight matrix A, to produce intermediate embedding information 514 having a value Ax. The weight matrix A is randomly initialized at the start of a training operation. The second feed-forward layer 510 multiples a second weight matrix B by the intermediate embedding information 514, to produce the second hidden state result 512 given by BAx. The weight matrix B is set to zero at the beginning of the training operation. A summation component 516 adds the first hidden state result 506 with the second hidden state result 512, to produce a combined result 518 given by given by h=Wₒx+BAx. Although not shown, a head neural network maps the combined result to a task-specific response.

In some implementations, the weight matrix Wₒ has dimensions of d×k, while the weight matrix A has dimensions of r×k and the matrix B has dimensions of d×r. The multiplication of matrix A by matrix B therefore yields a matrix having the same number of entries as the matrix Wₒ. The symbol r refers to the rank. Rank r is typically much smaller than d or k (e.g., r<<min (d,k)). As such, there are much fewer model weights to learn in the matrices A and B, compared to the weights in the base matrix Wₒ. In some implementations, r=32. Background information on the general topic of matrix decomposition in a training operation can found at Hu, at al., “LoRA: Low-Rank Adaptation of Large Language Models,” arXiv, arXiv: 2106.09685v2 [cs.CL], Oct. 16, 2021, 26 pages.

FIG. 5 uses the annotation “Q_{W}” to designate the quantization of weights, and “Qₐ” to designate the quantization of an activation (e.g., a value produced by a particular layer of the model). In some examples of the adapter model 106, the weight matrices A and B are quantized to 8-bit integers, and the activations (x, Ax, and BAx) are quantized to 16-bit integers. In some examples of the base model 104, Wₒ is quantized to 4-bit integers (e.g., 4-bit GPTQ per-channel quantization) or smaller integers. The head neural network (not shown in FIG. 5) uses 4-bit blockwise quantization.

### B. Training System

By way of introduction, the training system trains each adapter model with reference to an already trained and quantized base model 106. Training does not affect the weights Wₒ 112 of the base model 104. In other words, the weights Wₒ 112 of the base model 104 remain fixed throughout training. Since the adapter model 106 is trained based on computations made using the quantized version of the base model 104, the training can be said to take account for both its own quantization and the quantization of the base model 104. That is, the training of the adapter model compensates for any errors introduced in quantization of its own weights and activations and those of the base model 104. This is technically beneficial because it improves the accuracy of the adapter models and ensures their ability to seamlessly interact with the trained base model 104.

The weights Wₒ 112 of the base model 104 remain fixed not only during the training of individual adapter model, but remain the same over a span of time in which plural adapter models are trained. The base model weights Wₒ 112 are, in other words, an unchanging anchor over the span of time. This is technically beneficial because it ensures that adapter models in a library of adapter models will continue to successfully interact with the base model 104 regardless of when they were created.

Note that, in some computing platforms, weights are quantized, but subsequently stored as float types for compatibility with modern machine learning libraries. In this float-type form, the weights may be said to be dequantized. The weights in their dequantized form still manifest the loss that is produced as a result of quantization, meaning that the process of quantization is not lossless. As used herein, reference to a weight that has been quantized refers to either an original form of quantization or its dequantized counterpart in float form, both of which exhibit quantization loss. In either case, the training system takes account for this quantization loss during the training of each adapter model.

FIGS. 6 and 7 show two different implementations of a training system. The training system trains and quantizes new adapter models for use by the client system 120. But as explained with reference to FIG. 1, a user may alternatively choose a pre-trained adapter model from a library or online marketplace of pretrained adapter models.

More specifically, in FIG. 6, the client system 120 locally implements a training system 602. In some implementations, the local training system 602 is created by downloading a software program associated with the training system 602 from the adapter management system 132, and then installing and running the training system 602 like any other application. In this manner, the model extension system 102 ensures that any adapter model that is created by a user is attachable to the base model 104 and compatible therewith.

FIG. 7 is the implementation previously described with reference to FIG. 1. Here, the training system 146 of the adapter management system 132 trains a new adapter model, and downloads the trained adapter model to the client system 120. The training system 146 includes a setup interface (not shown) that enables a user to choose any of: a) the set of training examples to be used to produce the new adapter model; b) the type of pretrained model on which to commence training; c) the hyper-parameters to be used in training the adapter model; d) the number of epochs to be applied in training the adapter model; e) the loss function to be applied in training the adapter model; f) the type of quantization and encryption to be applied to the adapter model, and so on. As previously explained, a user is given the opportunity to choose a stock set of training examples provided by the adapter management system 132 or to upload a custom set of training examples

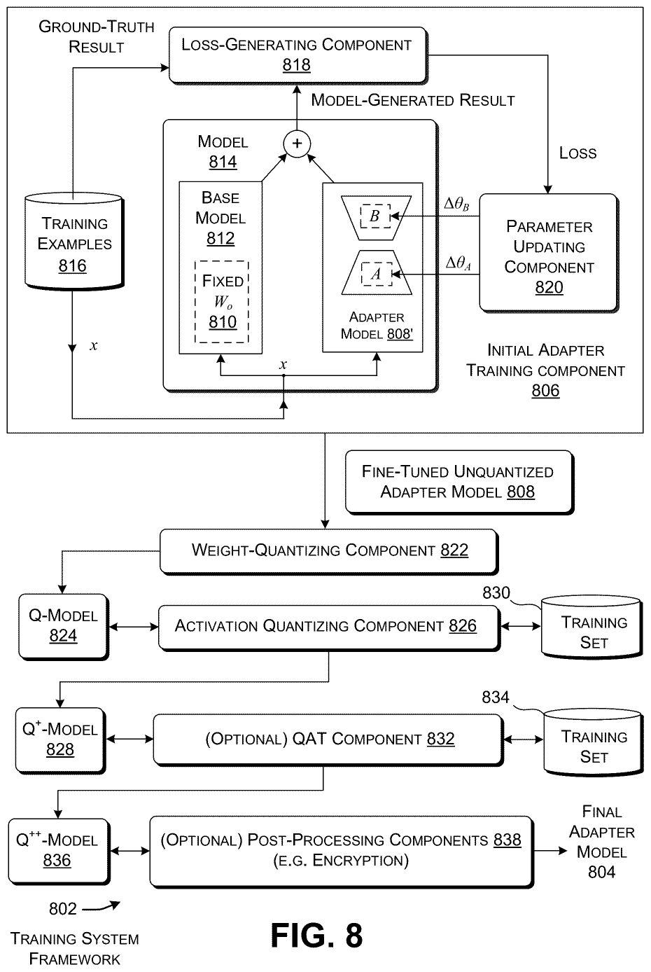

FIG. 8 shows one manner of operation of a training system 802 for training and quantizing an adapter model 804. Here, the training system 802 trains the adapter model 804 in plural stages or phases. In a first phase, an adapter training component 806 fine-tunes an initial unquantized adapter model 808′ by iteratively refining its weights. In some implementations, the weights include the weights in the weight matrices A and B, previously described in connection with FIG. 5. The weights Wₒ 810 of a base model 812 are quantized and remain fixed throughout the fine-tuning process and the processes to follow the fine-tuning processes. Further, the base model 812 is configured to receive and produce quantized activations throughout all processes shown in FIG. 8. At the completion of training, the adapter training component 806 produces a trained unquantized adapter model 808.

In some implementations, the adapter model 808′ and the base model 812 represent a model part 814, which is a part of a more encompassing model (not shown). For example, the model part 814 implements a particular layer of a multilayer neural language model (not shown). More specifically, the model part 814 is a layer of a pretrained language model, such as a LLaMA language model in the family of open-source LLaMA models or a Phi model in the family of Phi models described in “Phi-3 Technical Report: A Highly Capable Language Model Locally on Your Phone,” Models,” arXiv, arXiv: 2404.14219v4 [cs.CL], Aug. 30, 2024, 24 pages. The Phi-3 model is considered a small language model (SLM), although it still has 3.8B weights and is therefore large in comparison with applications which typically run on a user computing device.

A data store 816 stores a set of training examples. For an individual training example x, the base model 812 maps the training example x to a first hidden state result, and the adapter model 808′ maps the training example x to a second hidden state result. A combiner component sums the first hidden state result and the second hidden state result, to produce a combined model-generated result. A loss-generating component 818 generates loss information by comparing the combined model-generated result with a ground-truth result associated with the training example x. In actual practice, the adapter training component 806 operates on a batch of training examples at the same time, and produces loss information based on the batch.

In some implementations, the loss-generating component 818 compares a predicted next token with an expected next token, and expresses the loss information using any loss function (e.g., a cross entropy loss function, a contrastive loss function, a Kullback-Leibler (KL) divergence loss function, etc.). Alternatively, or in addition, the loss-generating component 818 performs reward-based training, such as Direct Preference Optimization (DPO) or Proximal Policy Optimization (PPO). A parameter-updating component 820 updates the parameters of the adapter model 808′ based on the loss information, e.g., using stochastic gradient descent in combination with back propagation.

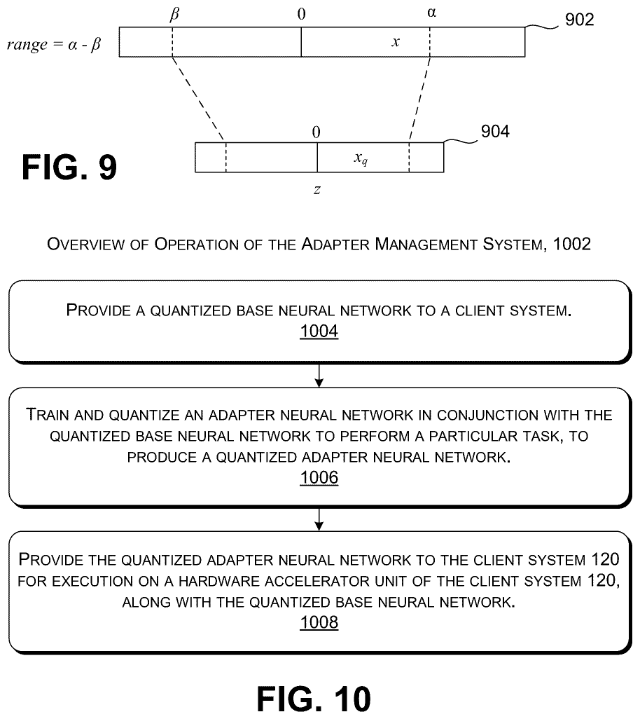

In some implementations, a weight-quantizing component 822 quantizes the weights of the unquantized adapter model 808 using post-training quantization (PTQ), to produce a weighted-quantized adapter model 824. With reference to FIG. 9, this process involves identifying a range 902 of weight magnitudes in the unquantized adapter model 808, e.g., a range of 32-bit floating point values. Here, the range extends from a smallest value of β to a largest value α. In some implementations, the weight-quantizing component 822 uses known clipping strategies to snap outlier magnitudes to either β or α. A scaling factor s defines how the given range 902 is mapped to a quantized range 904 of values. For example, the quantized values are 8-bit values extending from −127 to +127. In some implementations, the scaling factor is given by s=(2^{b-1}−1)/(α−β), in which b is the bit size of each quantized value. A zero point z in the range 904 is given by z=round (s·B)−2^{b-1}, in which round (·) is a rounding function.

An activation-quantizing component 826 produces an activation-quantized adapter model 828 by quantizing activations in the weight-quantized adapter model 824. In a dynamic mode, the activation-quantizing component 826 performs this task by observing the range of activations produced by the weight-quantized adapter model 824 (in conjunction with the quantized base model 812, which remains fixed) for a set of training examples in a training set (in a data store 830), and then choosing an appropriate scaling factor based on this range. The activation quantized adapter model 828 can perform this transformation using different techniques, such as minimizing the mean square error between unquantized activations and quantized activations. In a static mode, the activation-quantizing component 826 passes pre-generated calibration data through the base model 812 and the weight-quantized adapter model 824, determines the range of activation values, and chooses an appropriate scaling factor based thereon.

In some implementations, the training system 802 chooses the scaling factors for the individual adapter model 804 based on the scaling factors computed by the weight-quantizing component 822 and the activation-quantizing component 826. In other implementations, the training system 802 computes ranges of weight magnitudes and activation values for different adapter models associated with different tasks. The training system 802 then defines a master range of weight magnitudes and a master range of activation values that encompass the adapter-specific ranges. The training system 802 can also extend this master range by a certain percentage at both of its ends; this increases the probability that future adapters will have ranges that fall within the master range. The training system 802 then choses global scaling factors based on the master ranges. Determining a global scaling factor in this manner is equivalent to generating an average of individual scaling factors associated with different adapter models. The global scaling factors may be applied to all existing adapter models and any adapter model that is subsequently trained. This is based on the expectations that the training system 802 has reached a degree of confidence of the range of variation it will encounter in the future when training new adapters.

An optional quantization-aware training (QAT) component 832 fine-tunes the quantization parameters (e.g., scaling factors and zero points) computed in the manner described above based on a set of training examples in a data store 834. QAT training involves: a) injecting “fake” quantization nodes into the activation-quantized adapter model 828 (which of which performs quantization followed by dequantization); b) performing a forward pass through the activation-quantized adapter model 828 (and the base model 812) to compute loss information that depends, in part, on the choice of quantization used in the fake quantization nodes; and c) adjusting the weights of the activation-quantized adapter model 828 and the quantization parameters based on the loss information. In adjusting weights, the backward pass of QAT is performed without considering the contribution of the fake quantization nodes. This can be achieved through the use of straight-through estimators (STEs). The optional QAT component 832 produces a refined-quantized adapter model 836. One or more post-processing components 838 perform additional operations on the refined-quantized adapter model 836, such as by encrypting its weights and ensuring that the names of the different parts of the final adapter model 804 conform to a predefined namespace.

Other implementations use other strategies to train and quantize an adapter model. Generally, any implementation is capable of using any combination of fine-tuning, post-training quantization, and quantization-aware training (QAT). For example, another approach replaces all of the phases described above with a single quantization-aware training (QAT) operation followed by an encryption operation. Other approaches integrate the use the open-source QLoRA quantization strategy, the open-source QA-LoRA quantization strategy, etc.

As a final note, the base model 104 has been described as having fixed weights throughout this explanation. This represents one principal mode of operation of the model extension system 102. But it is also possible to upgrade the base model 104 itself on occasion, providing that steps are taken to ensure that the updated base model 104 remains compatible with existing adapter models.

### C. Illustrative Processes

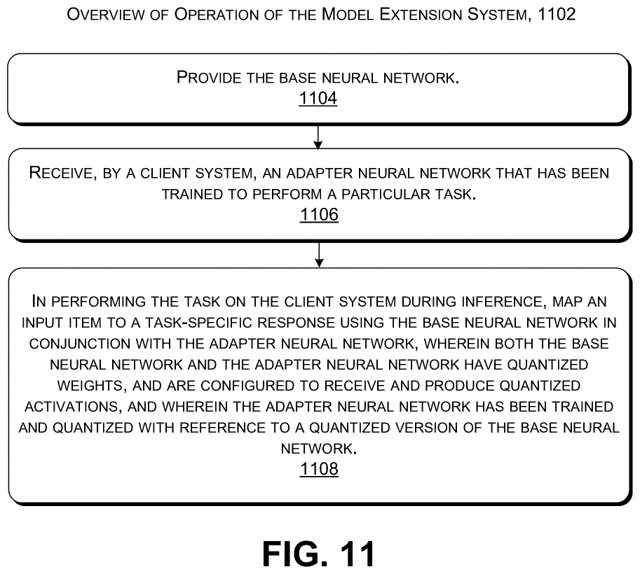

FIGS. 10 and 11 show two processes that represent an overview of the operation of the model extension system 102 of FIG. 1. Each of the processes is expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIGS. 13 and 14.

FIG. 10 shows a process 1002 by which the adapter management system 132 provides a base neural network (e.g., the base model 104) and an adapter neural network (e.g., an adapter model) to the client system 120. In block 1004, the adapter manager system 132 provides a quantized base neural network to the client system 120. In block 1006, the adapter manager system 132 trains and quantizes an adapter neural network in conjunction with the quantized base neural network to perform a particular task, to produce a quantized adapter neural network. In block 1008, the adapter manager system 132 provides the quantized adapter neural network to the client system 120 for execution on a hardware accelerator unit of the client system 120, along with the quantized base neural network.

FIG. 11 shows a process 1102 by which the client system 120 extends the capabilities of a base neural network (e.g., the base model 104). In block 1104, the client system 120 provides the base neural network. This operation is performed by downloading the base neural network from the adapter management system 132, or by accessing a version of the base neural network that is initially provided in the local storage of the client system 120. In block 1106, the client system 120 receives an adapter neural network that has been trained to perform a particular task. In block 1108, in performing the task during inference, the client system 120 maps an input item to a task-specific response using the base neural network in conjunction with the adapter neural network. The base neural network and the adapter neural network have quantized weights, and are configured to receive and produce quantized activations. The adapter neural network has been trained and quantized with reference to a quantized version of the base neural network.

### D. Illustrative Language Model

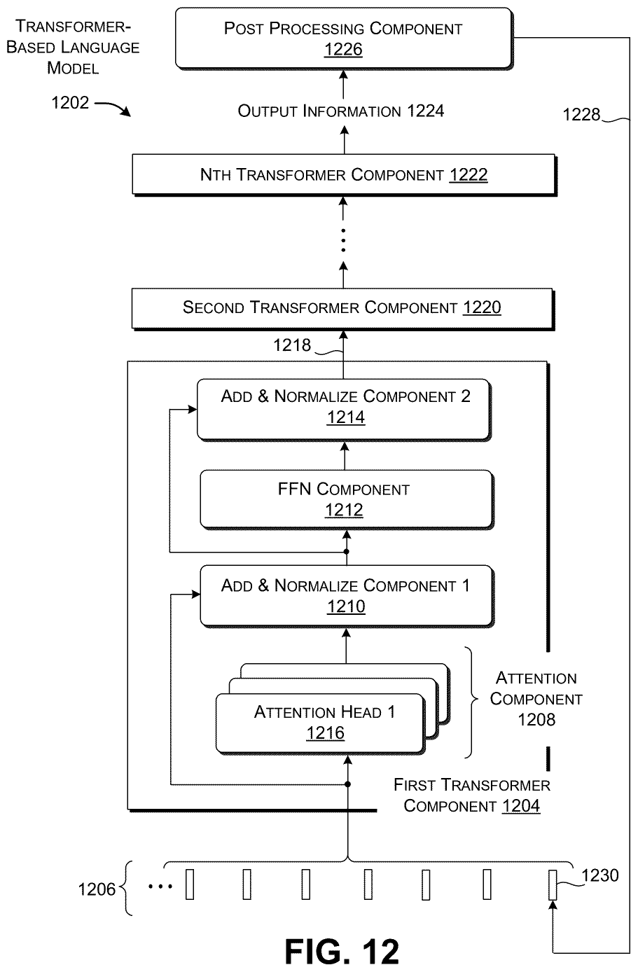

FIG. 12 shows a transformer-based language model (“language model”) 1202. Any layer of the language model 1202 can be expressed as a base model and a corresponding adapter model according to the principles set forth in the previous sections. More specifically, what has been referred to previously as a base model and adapter model may represent the operations in an individual layer of the language model 1202, or may represent plural component base models and associated adapter models associated with respective layers of the language model 1202. As noted at the end of this section, however, the transformer-based language model 1202 is just one example of a machine-trained model to which the principles set forth in previous sections can be applied.

The language model 1202 is composed, in part, of a pipeline of transformer components, including a first transformer component 1204. FIG. 12 provides details regarding one way to implement the first transformer component 1204. Although not specifically illustrated, other transformer components of the language model 1202 have the same architecture and perform the same functions as the first transformer component 1204 (but are governed by separate sets of weights)

The first transformer component 1204 operates on the position-supplemented embeddings 1206, e.g., produced by the embedding component 412 of FIG. 14. In some implementations, the first transformer component 1204 includes, in order, an attention component 1208, a first add-and-normalize component 1210, a feed-forward neural network (FFN) component 1212, and a second add-and-normalize component 1214.

The attention component 1208 determines how much emphasis should be placed on parts of input information when interpreting other parts of the input information. In some implementations, the attention component 1208 performs this analysis using the following equation:

$$Attention ( Q , K , V ) = softmax ( \frac{{QK}^{T}}{\sqrt{{d}_{k}}} ) V . \qquad ( 1 )$$

The attention component 1208 produces query information Q by multiplying the position-supplemented embeddings 1206 by a query weighting matrix W^{Q}. Similarly, the attention component 1208 produces key information K and value information V by multiplying the position-supplemented embeddings 1206 by a key weighting matrix W^{K} and a value weighting matrix W^{V}, respectively. To execute Equation (1), the attention component 1208 takes the dot product of Q with the transpose of K, and then divides the dot product by a scaling factor \sqrt{d}, to produce a scaled result. The symbol d represents the dimensionality of Q and K. The attention component 1208 takes the Softmax (normalized exponential function) of the scaled result, and then multiplies the result of the Softmax operation by V, to produce attention output information. In some cases, the attention component 1208 is said to perform masked attention insofar as the attention component 1208 masks output token information that, at any given time, has not yet been determined.

Note that FIG. 12 shows that the attention component 1208 is composed of plural attention heads, including a representative attention head 1216. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 1208 concatenates the output results of the attention component's separate attention heads, and then multiplies the results of this concatenation by another weight matrix W^{O}.

The add-and-normalize component 1210 includes a residual connection that combines (e.g., sums) input information fed to the attention component 1208 with the output information generated by the attention component 1208. The add-and-normalize component 1210 then normalizes the output information generated by the residual connection, e.g., by layer-normalizing values in the output information based on the mean and standard deviation of those values, or by performing root-mean-squared normalization. The other add-and-normalize component 1214 performs the same functions as the first-mentioned add-and-normalize component 1210. The FFN component 1212 transforms input information to output information using a feed-forward neural network having any number of layers.

The first transformer component 1204 produces output information 1218. A series of other transformer components (1220, . . . , 1222) perform the same functions as the first transformer component 1204, each operating on output information produced by its immediately preceding transformer component. Each transformer component uses its own level-specific set of machine-trained weights. The final transformer component 1222 in the language model 1202 produces final output information 1224.

In some implementations, a post-processing component 1226 performs post-processing operations on the final output information 1224. For example, the post-processing component 1226 performs a machine-trained linear transformation on the final output information 1224, and processes the results of this transformation using a Softmax component (not shown). The language model 1202 uses the output of the post-processing component 1226 to predict the next token in the input sequence of tokens. In some applications, the language model 1202 performs this task using a greedy selection approach (e.g., by selecting the token having the highest probability), or by using the beam search algorithm (e.g., by traversing a tree that expresses a search space of candidate next tokens).

In other implementations, the post-processing component 1226 represents a classification component that produces a classification result. In some implementations, the classification component is implemented by using a machine-trained linear neural network having one or more layers followed by a Softmax component. A BERT-based transformer model is one example of this kind of model.

In some implementations, the language model 1202 operates in an auto-regressive manner, as indicated by the loop 1228. To operate in this way, the language model 1202 appends a predicted token to the end of the sequence of input tokens, to provide an updated sequence of tokens. The predicted token leads to the production of a new position-supplemented vector 1230. In a next pass, the language model 1202 processes the updated sequence of position-supplemented vectors to generate a next predicted token. The language model 1202 repeats the above process until it generates a specified stop token.

The above-described implementation of the language model 1202 relies on a decoder-only architecture. Other implementations of the language model 1202 use an encoder-decoder transformer-based architecture. Here, a transformer-based decoder receives encoder output information produced by a transformer-based encoder, together with decoder input information. The encoder output information specifically includes KV information that serves an input to the attention components of the decoder (except the first transformer component).

As noted above, the base model and adapter models can be implemented using other kinds of machine-trained models besides, or in addition to, the particular transformer-based architecture shown in FIG. 12. The other machine-trained models include any of convolutional neural networks (CNNs), recurrent neural networks (RNNs), multilayer perceptrons (MLPs), other types of feed-forward neural networks, diffusion models, selective state space models (e.g., Mamba-type models), etc., or any combination thereof. Further note that the principles set forth herein are not limited to language models per se. Further, the models are capable of operating on any type (or combination of types) of input items, not limited to linguistic input items.

### E. Illustrative Computing Systems

FIG. 13 shows computing equipment 1302 that, in some implementations, is used to implement the model extension system 102. The computing equipment 1302 includes a set of local devices 1304 coupled to a set of servers 1306 via a computer network 1308. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, an immersive “cave,” a media device, a vehicle-borne computing system, any type of robot computing system, a computing system in a manufacturing system, etc. In some implementations, the computer network 1308 is implemented as a local area network, a wide area network (e.g., the Internet), one or more point-to-point links, or any combination thereof.

The bottom-most overlapping box in FIG. 13 indicates that the functionality of the model extension system 102 is capable of being spread across the local devices 1304 and/or the servers 1306 in any manner. In one example, as shown in FIG. 1, the adapter management system 132 is entirely implemented by the servers 1306 and the client system 120 is entirely implemented by one of the local devices. But any function allocated in FIG. 1 to the adapter management system 132 can instead be performed by a user device, and vice versa. For example, the training functionality of the model extension system 102 can be implemented by either (or both) the adapter management system 132 and/or a local device.

FIG. 14 shows a computing system 1402 that, in some implementations, is used to implement any aspect of the mechanisms set forth in the above-described figures. For instance, in some implementations, the type of computing system 1402 shown in FIG. 14 is used to implement any local computing device or any server shown in FIG. 13. In all cases, the computing system 1402 represents a physical and tangible processing mechanism.

The computing system 1402 includes a processing system 1404 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1402 also includes computer-readable storage media 1406, corresponding to one or more computer-readable media hardware units. The computer-readable storage media 1406 retains any kind of information 1408, such as machine-readable instructions, settings, model weights, and/or other data. In some implementations, the computer-readable storage media 1406 includes one or more solid-state devices, one or more hard disks, one or more optical disks, etc. Any instance of the computer-readable storage media 1406 represents a fixed or removable unit of the computing system 1402. Further, any instance of the computer-readable storage media 1406 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 1402 utilizes any instance of the computer-readable storage media 1406 in different ways. For example, in some implementations, any instance of the computer-readable storage media 1406 represents a hardware memory unit (such as random access memory (RAM)) for storing information during execution of a program by the computing system 1402, and/or a hardware storage unit (such as a hard disk) for retaining/archiving information on a more permanent basis. In the latter case, the computing system 1402 also includes one or more drive mechanisms 1410 (such as a hard drive mechanism) for storing and retrieving information from an instance of the computer-readable storage media 1406.

In some implementations, the computing system 1402 performs any of the functions described above when the processing system 1404 executes computer-readable instructions stored in any instance of the computer-readable storage media 1406. For instance, in some implementations, the computing system 1402 carries out computer-readable instructions to perform each block of the processes described with reference to FIGS. 10 and 11. FIG. 14 generally indicates that hardware logic circuitry 1412 includes any combination of the processing system 1404 and the computer-readable storage media 1406.

In addition, or alternatively, the processing system 1404 includes one or more other configurable logic units that perform operations using a collection of logic gates, such as field-programmable gate arrays (FPGAs), etc. In these implementations, the processing system 1404 effectively incorporates a storage device that stores computer-readable instructions, insofar as the configurable logic units are configured to execute the instructions and therefore embody or store these instructions.

In some cases (e.g., in the case in which the computing system 1402 represents a user computing device), the computing system 1402 also includes an input/output interface 1414 for receiving various inputs (via input devices 1416), and for providing various outputs (via output devices 1418). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1420 and an associated graphical user interface presentation (GUI) 1422. The display device 1420 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1402 also includes one or more network interfaces 1424 for exchanging data with other devices via one or more communication conduits 1426. One or more communication buses 1428 communicatively couple the above-described units together.

The communication conduit(s) 1426 is implemented in any manner, e.g., by a local area computer network, a wide area computer network (e.g., the Internet), point-to-point connections, or any combination thereof. The communication conduit(s) 1426 include any combination of hardwired links, wireless links, routers, gateway functionality, name servers, etc., governed by any protocol or combination of protocols.

FIG. 14 shows the computing system 1402 as being composed of a discrete collection of separate units. In some cases, the collection of units corresponds to discrete hardware units provided in a computing device chassis having any form factor. FIG. 14 shows illustrative form factors in its bottom portion. In other cases, the computing system 1402 includes a hardware logic unit that integrates the functions of two or more of the units shown in FIG. 14. For instance, in some implementations, the computing system 1402 includes a system on a chip (SoC or SOC), corresponding to an integrated circuit that combines the functions of two or more of the units shown in FIG. 14.

The following summary provides a set of illustrative examples of the technology set forth herein.
(A1) According to a first aspect, a method (e.g., the process 1104) for extending capabilities of a base neural network (e.g., the base model 104). The method includes: providing (e.g., in block 1104) the base neural network; receiving (e.g., in block 1106), by a client system (e.g., the client system 120), an adapter neural network that has been trained to perform a particular task; and, in performing the task on the client system during inference, mapping (e.g., in block 1108) an input item to a task-specific response using the base neural network in conjunction with the adapter neural network. Both the base neural network and the adapter neural network have quantized weights, and are configured to receive and produce quantized activations. The weights of the adapter neural network have been produced by training and quantizing the weights of the adapter neural network based on a quantized version of the base neural network.
(A2) According to some aspects of A1, the base neural network is a language model.
(A3) According to some aspects of A1 or A2, the base neural network and the adapter neural network execute operations on a hardware accelerator unit of the client system.
(A4) According to some aspects of A3, the hardware accelerator unit is a neural processing unit of the client system.
(A5) According to some aspects of the A3 or A4, the mapping includes: using the base neural network in conjunction with the base neural network to map the input item to a hidden state result; and using a head neural network to map the hidden state result to the task-specific response on a central processing unit of the client system.
(A6) According to some aspects of any of A3-A5, the method further includes, in an embedding neural network that runs on the central processing unit of the client system, mapping the input item to input-item embedding information. The adapter neural network and the base neural network operate on the input-item embedding information.
(A7) According to some aspects of any of A1-A6, the adapter neural network operates in parallel with and/or in series with the base neural network.
(A8) According to some aspects of any of A1-A7, the mapping during inference includes: receiving the input item; mapping the input item to a first hidden state result using the base neural network and mapping the input item to a second hidden state result using the adapter neural network; combining the first hidden state result and the second hidden state result to produce a combined result; mapping the combined result to the task-specific response using a head neural network; and providing the task-specific response to an application.
(A9) According to some aspects of any of A1-A8, the providing the base neural network includes receiving quantized weights of the base neural network from a network-accessible source, and the receiving the adapter neural network includes receiving quantized weights of the adapter neural network from the network-accessible source.
(A10) According to some aspects of any of A1-A9, the adapter neural network is one of plural adapter neural networks that have been received from a network-accessible source, and the base model network operates in conjunction with any one or more of the plural adapter neural networks when invoked by one or more corresponding applications.
(A11) According to some aspects of A10, the plural adapter models are separately maintained in memory during inference.
(A12) According to some aspects of any of A1-A11, the adapter neural network is trained and quantized by any combination of fine-tuning training of weights, post-training quantization, and quantization-aware training.
(A13) According to some aspects of A1, a training system trains the adapter neural network by performing the fine-tuning, followed by the post-training quantization, followed by the quantization-aware training.
(A14) According to some aspects of any of A1-A13, the method further includes: computing individual weight quantization scaling factors and individual activation scaling factors for a plurality of individual adapters; and choosing a final weight quantization scaling factor that encompasses the individual weight quantization scaling factors, and choosing a final activation scaling factor that encompasses the individual activation scaling factors. The final weight quantization scaling factor and the final activation scaling factor are applied to plural adapter models.
(B1) According to another aspect, a method for extending capabilities of a base neural network (e.g., the base model 104) is described. The method includes: providing the base neural network; receiving a first adapter neural network that has been trained to perform a first task when operating in conjunction with the base neural network; receiving a second adapter neural network that has been trained to perform a second task when operating in conjunction with the base neural network; mapping an input item to a response using the base neural network, the first adapter neural network, and the second adapter neural network; and providing the task-specific response to an application. The first adapter neural network and the second adapter neural network are maintained separately in memory during inference.
(C1) According to another aspect, a method (e.g., the process 1004) is described that includes: providing (e.g., in block 1004) a quantized base neural network (e.g., the base model 104) to a client system (e.g., the client system 120); training and quantizing (e.g., in block 1006) an adapter neural network in conjunction with the quantized base neural network to perform a particular task, to produce a quantized adapter neural network; and providing (e.g., in block 1008) the quantized adapter neural network to the client system for execution on a hardware accelerator unit (e.g., the NPU 408) of the client system, along with the quantized base neural network. The training and quantizing includes any combination of fine-tuning training of weights, post-training quantization, and quantization-aware training.

In yet another aspect, some implementations of the technology described herein include a computing system (e.g., the computing system 1402) that includes a processing system (e.g., the processing system 1404) having a processor. The computing system also includes a storage device (e.g., the computer-readable storage media 1406) for storing computer-readable instructions (e.g., the information 1408). The processing system executes the computer-readable instructions to perform any of the methods described herein (e.g., any individual method of the methods of A1-A14. B1, or C1).

In yet another aspect, some implementations of the technology described herein include a computer-readable storage medium (e.g., the computer-readable storage media 1406) for storing computer-readable instructions (e.g., the information 1408). A processing system (e.g., the processing system 1404) executes the computer-readable instructions to perform any of the operations described herein (e.g., the operations in any individual method of the methods of A1-A14, B1, or C1).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 1412 of FIG. 14. The term “logic” likewise encompasses various physical and tangible mechanisms for performing a task. For instance, each processing-related operation illustrated in the flowcharts of FIGS. 15 and 16 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for extending capabilities of a base neural network, comprising:
providing the base neural network;
receiving, by a client system, an adapter neural network that has been trained to perform a particular task; and
in performing the task on the client system during inference, mapping an input item to a task-specific response using the base neural network in conjunction with the adapter neural network,
wherein both the base neural network and the adapter neural network have quantized weights, and are configured to receive and produce quantized activations, and
wherein the adapter neural network has been trained and quantized with reference to a quantized version of the base neural network.

2. The method of claim 1, wherein the base neural network is a language model.

3. The method of claim 1, wherein the base neural network and the adapter neural network execute operations on a hardware accelerator unit of the client system.

4. The method of claim 3, wherein the hardware accelerator unit is a neural processing unit of the client system.

5. The method of claim 3, wherein the mapping comprises:
using the base neural network in conjunction with the base neural network to map the input item to a hidden state result; and
using a head neural network to map the hidden state result to the task-specific response on a central processing unit of the client system.

6. The method of claim 3, further comprising, in an embedding neural network that runs on a central processing unit of the client system, mapping the input item to input-item embedding information,
wherein the adapter neural network and the base neural network operate on the input-item embedding information.

7. The method of claim 1, wherein the adapter neural network operates in parallel with and/or in series with the base neural network.

8. The method of claim 1, wherein the mapping during inference comprises:
receiving the input item;
mapping the input item to a first hidden state result using the base neural network and mapping the input item to a second hidden state result using the adapter neural network;
combining the first hidden state result and the second hidden state result to produce a combined result;
mapping the combined result to the task-specific response using a head neural network; and
providing the task-specific response to an application.

9. The method of claim 1,
wherein the providing the base neural network includes receiving quantized weights of the base neural network from a network-accessible source, and
wherein the receiving the adapter neural network includes receiving quantized weights of the adapter neural network from the network-accessible source.

10. The method of claim 1, wherein the adapter neural network is one of plural adapter neural networks that have been received from a network-accessible source, and wherein the base model network operates in conjunction with any one or more of the plural adapter neural networks when invoked by one or more corresponding applications.

11. The method of claim 10, wherein the plural adapter models are separately maintained in memory during inference.

12. The method of claim 1, wherein the adapter neural network has been trained and quantized by any combination of fine-tuning training of weights, post-training quantization, and quantization-aware training.

13. The method of claim 12, wherein a training system trains the adapter neural network by performing the fine-tuning, followed by the post-training quantization, followed by the quantization-aware training.

14. The method of claim 1, further comprising:
computing individual weight quantization scaling factors and individual activation scaling factors for a plurality of individual adapters; and
choosing a final weight quantization scaling factor that encompasses the individual weight quantization scaling factors, and choosing a final activation scaling factor that encompasses the individual activation scaling factors,
the final weight quantization scaling factor and the final activation scaling factor being applied to plural adapter models.

15. A client system for extending capabilities of a base neural network, comprising:
an instruction data store for storing computer-readable instructions; and
a processing system for executing the computer-readable instructions in the data store, to perform operations including:
providing the base neural network;
receiving a first adapter neural network that has been trained to perform a first task when operating in conjunction with the base neural network;
receiving a second adapter neural network that has been trained to perform a second task when operating in conjunction with the base neural network;
mapping an input item to a response using the base neural network, the first adapter neural network, and the second adapter neural network; and
providing the task-specific response to an application,
wherein the first adapter neural network and the second adapter neural network are maintained separately in memory during inference.

16. The client system of claim 15,
wherein the base neural network, the first adapter neural network, and the second adapter neural network have quantized weights, and are configured to receive and produce quantized activations.

17. The client system of claim 15, wherein the adapter neural network has been trained and quantized with reference to a quantized version of the base neural network.

18. The computing system of claim 15, wherein the base neural network, the first adapter neural network, and the second adapter neural network execute operations on a hardware accelerator unit of the client system.

19. The computing system of claim 15, wherein, in performing another task, the first adapter neural network operates in conjunction with the base neural network to produce a first response given a first input item, and in parallel therewith, the second adapter neural network operates in conjunction with the base neural network to produce a second response given a second input item.

20. A computer-readable storage medium for storing computer-readable instructions, a processing system executing the computer-readable instructions to perform operations, the operations comprising:
providing a quantized base neural network to a client system;
training and quantizing an adapter neural network in conjunction with the quantized base neural network to perform a particular task, to produce a quantized adapter neural network; and
providing the quantized adapter neural network to the client system for execution on a hardware accelerator unit of the client system, along with the quantized base neural network,
wherein the training and quantizing includes any combination of fine-tuning training of weights, post-training quantization, and quantization-aware training.
